(19) United States
(12) Patent Application Publication
(10) Pub. No.: US 2009/0246499 A1
(43) Pub. Date: Oct. 1, 2009

(54) Silicone Resin Film and Method of Preparing Same

(76) Inventors: Dimitris Katsoulis, Midland, MI (US); Elizabeth Mc Quiston, Midland, MI (US); Michitaka Suto, Kanagawa (JP)

Correspondence Address: DOW CORNING CORPORATION CO1232, 2200 W. SALZBURG ROAD, P.O. BOX 994, MIDLAND, MI, 48686-0994, US

(21) Appl. No.: 12/441,586

(22) PCT Filed: Aug. 16, 2007
(86) PCT No.: PCT/US07/18313

§ 371 Date: Mar. 17, 2009

Related U.S. Application Data
(60) Provisional application No. 60/849,728, filed on Oct. 5, 2006.

(51) Int. Cl. B32B 5/00; B32B 37/00

(52) U.S. Cl. 428/220; 156/278

(57) ABSTRACT

A method of preparing a silicone resin film comprising coating a first release liner with a filled silicone composition comprising a hydrosilylation-curable silicone composition and a flame retardant filler, applying a second release liner to the coated first release liner to form an assembly, compressing the assembly; and curing the silicone resin of the compressed assembly, wherein the silicone resin film has a thickness of from 1 to 500 μm; and a silicone resin film.

### CROSS-REFERENCE TO RELATED APPLICATIONS

This application claims the benefit of U.S. Provisional Patent Application 60/849,728 filed Oct. 5, 2006 under 35 U.S.C. §119 (e). U.S. Provisional Patent Application No. 60/849,728 is hereby incorporated by reference.

### FIELD OF THE INVENTION

The present invention relates to a method of preparing a silicone resin film and more particularly to a method comprising coating a first release liner with a filled silicone composition comprising a hydrosilylation-curable silicone composition and a flame retardant filler; applying a second release liner to the coated first release liner to form an assembly; compressing the assembly; and curing the silicone resin of the compressed assembly; wherein the silicone resin film has a thickness of from 1 to 500 μm. The present invention also relates to a silicone resin film.

### BACKGROUND OF THE INVENTION

Silicone resins are useful in a variety of applications by virtue of their unique combination of properties, including high thermal stability, good moisture resistance, excellent flexibility, high oxygen resistance, low dielectric constant, and high transparency. For example, silicone resins are widely used as protective or dielectric coatings in the automotive, electronic, construction, appliance, and aerospace industries.

Although silicone resin coatings can be used to protect, insulate, or bond a variety of substrates, free standing silicone resin films have limited utility due to low tear strength, high brittleness, low glass transition temperature, high coefficient of thermal expansion, and high flammability. Consequently, there is a need for free standing silicone resin films having improved mechanical, thermal, and flammability properties.

### SUMMARY OF THE INVENTION

The present invention is directed to a method of preparing a silicone resin film, the method comprising:

(i) coating a first release liner with a filled silicone composition, wherein the filled silicone composition comprises:

a hydrosilylation-curable silicone composition comprising a silicone resin having an average of at least two silicon-bonded alkenyl groups or silicon-bonded hydrogen atoms per molecule, and

a flame retardant filler;

(ii) applying a second release liner to the coated first release liner to form an assembly;

(iii) compressing the assembly; and

(iv) curing the silicone resin of the compressed assembly; wherein the silicone resin film has a thickness of from 1 to 500 μm.

The present method is also directed to a silicone resin film prepared according to the aforementioned method.

The present invention is further directed to a silicone resin film comprising:

a cured product of at least one silicone resin having an average of at least two silicon-bonded alkenyl groups or silicon-bonded hydrogen atoms per molecule; and

a flame retardant filler; wherein the silicone resin film has a thickness of from 1 to 500 μm.

The silicone resin film of the present invention has low coefficient of thermal expansion, high tensile strength, high modulus, and low flammability compared to a silicone resin film prepared from the same silicone composition absent the flame retardant filler.

The silicone resin film of the present invention is useful in applications requiring films having low flammability, and high thermal stability, flexibility, mechanical strength, and transparency. For example, the silicone resin film can be used as an integral component of flexible displays, solar cells, flexible electronic boards, side interior panels and ceiling panels for aircraft, touch screens, fire-resistant wallpaper, and impact-resistant windows. The film is also a suitable substrate for transparent or nontransparent electrodes.

### DETAILED DESCRIPTION OF THE INVENTION

As used herein, the term “free of aliphatic unsaturation” means the hydrocarbyl or halogen-substituted hydrocarbyl group does not contain an aliphatic carbon-carbon double bond or carbon-carbon triple bond. Also, the term “mol % of the groups R² in the silicone resin are alkenyl” is defined as the ratio of the number of moles of silicon-bonded alkenyl groups in the silicone resin to the total number of moles of the groups R² in the resin, multiplied by 100. Further, the term “mol % of the groups R⁴ in the silicone resin are hydrogen” is defined as the ratio of the number of moles of silicon-bonded hydrogen atoms in the silicone resin to the total number of moles of the groups R⁴ in the resin, multiplied by 100.

A method of preparing a silicone resin film according to the present invention comprises:

(i) coating a first release liner with a filled silicone composition, wherein the filled silicone composition comprises:

a hydrosilylation-curable silicone composition comprising a silicone resin having an average of at least two silicon-bonded alkenyl groups or silicon-bonded hydrogen atoms per molecule, and

a flame retardant filler;

(ii) applying a second release liner to the coated first release liner to form an assembly;

(iii) compressing the assembly; and

(iv) curing the silicone resin of the compressed assembly; wherein the silicone resin film has a thickness of from 1 to 500 μm.

In step (i) of the method of preparing a silicone resin film, a first release liner is coated with a filled silicone composition, wherein the filled silicone composition comprises a hydrosilylation-curable silicone composition comprising a silicone resin having an average of at least two silicon-bonded alkenyl groups or silicon-bonded hydrogen atoms per molecule, and a flame retardant filler.

The first release liner can be any rigid or flexible material having a surface from which the silicone resin film can be removed without damage by delamination after the silicone resin is cured, as described below. Examples of release liners include, but are not limited to, silicon, quartz; fused quartz; aluminum oxide; ceramics; glass; metal foils; polyolefins such as polyethylene, polypropylene, polystyrene, and polyethyleneterephthalate; fluorocarbon polymers such as polytetrafluoroethylene and polyvinylfluoride; polyamides such as Nylon; polyimides; polyesters such as poly(methyl methacrylate); epoxy resins; polyethers; polycarbonates; polysulfones; and polyether sulfones. The release liner can also be a material, as exemplified above, having a surface treated with a release agent, such as a silicone release agent.

The hydrosilylation-curable silicone composition can be any hydrosilylation-curable silicone composition containing a silicone resin having an average of at least two silicon-bonded alkenyl groups or silicon-bonded hydrogen atoms per molecule. Typically, the hydrosilylation-curable silicone composition comprises the aforementioned silicone resin; an organosilicon compound in an amount sufficient to cure the silicone resin, wherein the organosilicon compound has an average of at least two silicon-bonded hydrogen atoms or silicon-bonded alkenyl groups per molecule capable of reacting with the silicon-bonded alkenyl groups or silicon-bonded hydrogen atoms in the silicone resin; and a catalytic amount of a hydrosilylation catalyst.

The silicone resin of the hydrosilylation-curable silicone composition is typically a copolymer containing T and/or Q siloxane units in combination with M and/or D siloxane units. For example, the silicone resin can be a DT resin, an MT resin, an MDT resin, a DTQ resin, and MTQ resin, and MDTQ resin, a DQ resin, an MQ resin, a DTQ resin, an MTQ resin, or an MDQ resin.

The silicone resin typically has a number-average molecular weight (Mₙ) of from 500 to 50,000, alternatively from 500 to 10,000, alternatively 1,000 to 3,000, where the molecular weight is determined by gel permeation chromatography employing a refractive index detector and silicone resin (MQ) standards.

The viscosity of the silicone resin at 25° C. is typically from 0.01 to 100,000 Pa·s, alternatively from 0.1 to 10,000 Pa·s, alternatively from 1 to 100 Pa·s.

The silicone resin typically contains less than 10% (w/w), alternatively less than 5% (w/w), alternatively less than 2% (w/w), of silicon-bonded hydroxy groups, as determined by ²⁹Si NMR.

According to one embodiment, the hydrosilylation-curable silicone composition comprises (A) a silicone resin having the formula (R¹R²₂SiO_{1/2})_{w}(R²₂SiO_{2/2})ₓ (R¹SiO_{3/2})_{y}(SiO_{4/2})_{z} (I), wherein R¹ is C₁ to C₁₀ hydrocarbyl or C₁ to C₁₀ halogen-substituted hydrocarbyl, both free of aliphatic unsaturation, R² is R¹ or alkenyl, w is from 0 to 0.8, x is from 0 to 0.6, y is from 0 to 0.99, z is from 0 to 0.35, w+x+y+z=1, y+z is from 0.2 to 0.99, and w+x is from 0.01 to 0.8, provided the silicone resin has an average of at least two silicon-bonded alkenyl groups per molecule; (B) an organosilicon compound having an average of at least two silicon-bonded hydrogen atoms per molecule in an amount sufficient to cure the silicone resin; and (C) a catalytic amount of a hydrosilylation catalyst.

Component (A) is at least one silicone resin having the formula (R¹R²₂SiO_{1/2})_{w}(R²₂SiO_{2/2})ₓ(R¹SiO_{3/2})_{y}(SiO_{4/2})_{z} (I), wherein R¹ is C₁ to C₁₀ hydrocarbyl or C₁ to C₁₀ halogen-substituted hydrocarbyl, both free of aliphatic unsaturation, R² is R¹ or alkenyl, w is from 0 to 0.8, x is from 0 to 0.6, y is from 0 to 0.99, z is from 0 to 0.35, w+x+y+z=1, y+z is from 0.2 to 0.99, and w+x is from 0.01 to 0.8, provided the silicone resin has an average of at least two silicon-bonded alkenyl groups per molecule.

The hydrocarbyl and halogen-substituted hydrocarbyl groups represented by R¹ are free of aliphatic unsaturation and typically have from 1 to 10 carbon atoms, alternatively from 1 to 6 carbon atoms. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and naphthyl; alkaryl, such as tolyl and xylyl; and aralkyl, such as benzyl and phenethyl. Examples of halogen-substituted hydrocarbyl groups represented by R¹ include, but are not limited to 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

The alkenyl groups represented by R², which may be the same or different, typically have from 2 to about 10 carbon atoms, alternatively from 2 to 6 carbon atoms, and are exemplified by, but not limited to, vinyl, allyl, butenyl, hexenyl, and octenyl.

In the formula (I) of the silicone resin, the subscripts w, x, y, and z are mole fractions. The subscript w typically has a value of from 0 to 0.8, alternatively from 0.02 to 0.75, alternatively from 0.05 to 0.3; the subscript x typically has a value of from 0 to 0.6, alternatively from 0 to 0.45, alternatively from 0 to 0.25; the subscript y typically has a value of from 0 to 0.99, alternatively from 0.25 to 0.8, alternatively from 0.5 to 0.8; the subscript z typically has a value of from 0 to 0.35, alternatively from 0 to 0.25, alternatively from 0 to 0.15. Also, the sum y+z is typically from 0.2 to 0.99, alternatively from 0.5 to 0.95, alternatively from 0.65 to 0.9. Further, the sum w+x is typically from 0.01 to 0.80, alternatively from 0.05 to 0.5, alternatively from 0.1 to 0.35.

Typically at least 50 mol %, alternatively at least 65 mol %, alternatively at least 80 mol % of the groups R² in the silicone resin are alkenyl.

Examples of silicone resins having the formula (I) include, but are not limited to, resins having the following formulae: (Vi₂MeSiO_{1/2})_{0.25}(PhSiO_{3/2})_{0.75}, (ViMe₂SiO_{1/2})_{0.25}(PhSiO_{3/2})_{0.75}, (ViMe₂SiO_{1/2})_{0.25}(MeSiO_{3/2})_{0.25}(PhSiO_{3/2})_{0.50}, (ViMe₂SiO_{1/2})_{0.15}(PhSiO_{3/2})_{0.75} (SiO_{4/2})_{0.1}, and (Vi₂MeSiO_{1/2})_{0.15}(ViMe₂SiO_{1/2})_{0.1}(PhSiO_{3/2})_{0.75}, where Me is methyl, Vi is vinyl, Ph is phenyl, and the numerical subscripts outside the parenthesis denote mole fractions. Also, in the preceding formulae, the sequence of units is unspecified.

Component (A) can be a single silicone resin or a mixture comprising two or more different silicone resins, each as described above.

Methods of preparing silicone resins containing silicon-bonded alkenyl groups are well known in the art; many of these resins are commercially available. Such silicone resins are typically prepared by cohydrolyzing the appropriate mixture of chlorosilane precursors in an organic solvent, such as toluene. For example, a silicone resin consisting essentially of R¹R²₂SiO_{1/2} units and R¹SiO_{3/2} units can be prepared by cohydrolyzing a compound having the formula R¹R²₂SiCl and a compound having the formula R¹SiCl₃ in toluene, where R¹ and R² are as defined and exemplified above. The aqueous hydrochloric acid and silicone hydrolyzate are separated and the hydrolyzate is washed with water to remove residual acid and heated in the presence of a mild condensation catalyst to “body” the resin to the requisite viscosity. If desired, the resin can be further treated with a condensation catalyst in an organic solvent to reduce the content of silicon-bonded hydroxy groups. Alternatively, silanes containing hydrolysable groups other than chloro, such —Br, —I, —OCH₃, —OC(O)CH₃, —N(CH₃)₂, NHCOCH₃, and —SCH₃, can be utilized as starting materials in the cohydrolysis reaction. The properties of the resin products depend on the types of silanes, the mole ratio of silanes, the degree of condensation, and the processing conditions.

Component (B) is at least one organosilicon compound having an average of at least two silicon-bonded hydrogen atoms per molecule in an amount sufficient to cure the silicone resin of component (A).

The organosilicon compound has an average of at least two silicon-bonded hydrogen atoms per molecule, alternatively at least three silicon-bonded hydrogen atoms per molecule. It is generally understood that cross-linking occurs when the sum of the average number of alkenyl groups per molecule in component (A) and the average number of silicon-bonded hydrogen atoms per molecule in component (B) is greater than four.

The organosilicon compound can be an organohydrogensilane or an organohydrogensiloxane. The organohydrogensilane can be a monosilane, disilane, trisilane, or polysilane. Similarly, the organohydrogensiloxane can be a disiloxane, trisiloxane, or polysiloxane. The structure of the organosilicon compound can be linear, branched, cyclic, or resinous. Cyclosilanes and cyclosiloxanes typically have from 3 to 12 silicon atoms, alternatively from 3 to 10 silicon atoms, alternatively from 3 to 4 silicon atoms. In acyclic polysilanes and polysiloxanes, the silicon-bonded hydrogen atoms can be located at terminal, pendant, or at both terminal and pendant positions.

Examples of organohydrogensilanes include, but are not limited to, diphenylsilane, 2-chloroethylsilane, bis[(p-dimethylsilyl)phenyl]ether, 1,4-dimethyldisilylethane, 1,3,5-tris(dimethylsilyl)benzene, 1,3,5-trimethyl-1,3,5-trisilane, poly(methylsilylene)phenylene, and poly(methylsilylene)methylene.

The organohydrogensilane can also have the formula HR¹₂Si—R³—SiR¹₂H, wherein R¹ is C₁ to C₁₀ hydrocarbyl or C₁ to C₁₀ halogen-substituted hydrocarbyl, both free of aliphatic unsaturation, and R³ is a hydrocarbylene group free of aliphatic unsaturation having a formula selected from:

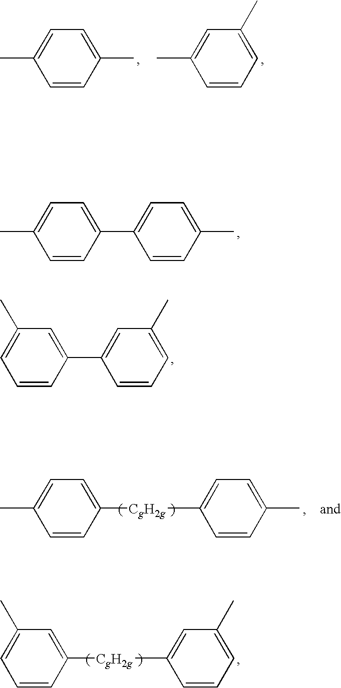

wherein g is from 1 to 6. The hydrocarbyl and halogen-substituted hydrocarbyl groups represented by R¹ are as defined and exemplified above for the silicone resin of component (A).

Examples of organohydrogensilanes having the formula HR¹₂Si—R³—SiR¹₂H, wherein R¹ and R³ are as described and exemplified above include, but are not limited to, silanes having the following formulae:

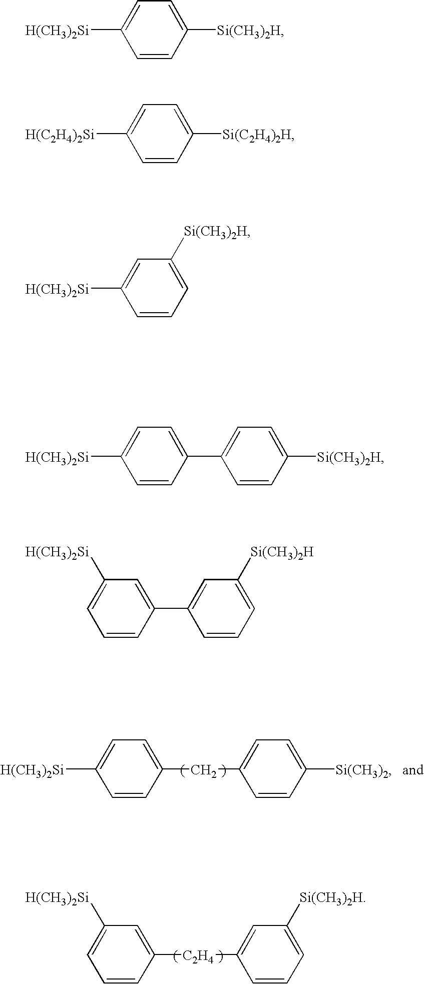

Examples of organohydrogensiloxanes include, but are not limited to 1,1,3,3-tetramethyldisiloxane, 1,1,3,3-tetraphenyldisiloxane, phenyltris(dimethylsiloxy)silane, 1,3,5-trimethylcyclotrisiloxane, a trimethylsiloxy-terminated poly(methylhydrogensiloxane), a trimethylsiloxy-terminated poly(dimethylsiloxane/methylhydrogensiloxane), a dimethylhydrogensiloxy-terminated poly(methylhydrogensiloxane), and a resin consisting essentially of HMe₂SiO_{1/2} units, Me₃SiO_{1/2} units, and SiO_{4/2} units, wherein Me is methyl.

Component (B) can be a single organosilicon compound or a mixture comprising two or more different organosilicon compounds, each as described above. For example, component (B) can be a single organohydrogensilane, a mixture of two different organohydrogensilanes, a single organohydrogensiloxane, a mixture of two different organohydrogensiloxanes, or a mixture of an organohydrogensilane and an organohydrogensiloxane.

The concentration of component (B) is sufficient to cure (cross-link) the silicone resin of component (A). The exact amount of component (B) depends on the desired extent of cure, which generally increases as the ratio of the number of moles of silicon-bonded hydrogen atoms in component (B) to the number of moles of alkenyl groups in component (A) increases. The concentration of component (B) is typically sufficient to provide from 0.4 to 2 moles of silicon-bonded hydrogen atoms, alternatively from 0.8 to 1.5 moles of silicon-bonded hydrogen atoms, alternatively from 0.9 to 1.1 moles of silicon-bonded hydrogen atoms, per mole of alkenyl groups in component (A).

Methods of preparing organosilicon compounds containing silicon-bonded hydrogen atoms are well known in the art. For example, organohydrogensilanes can be prepared by reaction of Grignard reagents with alkyl or aryl halides. In particular, organohydrogensilanes having the formula HR¹₂Si—R³—SiR¹₂H can be prepared by treating an aryl dihalide having the formula R³X₂ with magnesium in ether to produce the corresponding Grignard reagent and then treating the Grignard reagent with a chlorosilane having the formula HR¹₂SiCl, where R¹ and R³ are as described and exemplified above.

Methods of preparing organohydrogensiloxanes, such as the hydrolysis and condensation of organohalosilanes, are also well known in the art.

Component (C) of the hydrosilylation-curable silicone composition is at least one hydrosilylation catalyst that promotes the addition reaction of component (A) with component (B). The hydrosilylation catalyst can be any of the well-known hydrosilylation catalysts comprising a platinum group metal, a compound containing a platinum group metal, or a microencapsulated platinum group metal-containing catalyst. Platinum group metals include platinum, rhodium, ruthenium, palladium, osmium and iridium. Preferably, the platinum group metal is platinum, based on its high activity in hydrosilylation reactions.

Preferred hydrosilylation catalysts include the complexes of chloroplatinic acid and certain vinyl-containing organosiloxanes disclosed by Willing in U.S. Pat. No. 3,419,593, which is hereby incorporated by reference. A preferred catalyst of this type is the reaction product of chloroplatinic acid and 1,3-diethenyl-1,1,3,3-tetramethyldisiloxane.

The hydrosilylation catalyst can also be a microencapsulated platinum group metal-containing catalyst comprising a platinum group metal encapsulated in a thermoplastic resin. Compositions containing microencapsulated hydrosilylation catalysts are stable for extended periods of time, typically several months or longer, under ambient conditions, yet cure relatively rapidly at temperatures above the melting or softening point of the thermoplastic resin(s). Microencapsulated hydrosilylation catalysts and methods of preparing them are well known in the art, as exemplified in U.S. Pat. No. 4,766,176 and the references cited therein; and U.S. Pat. No. 5,017,654.

Component (C) can be a single hydrosilylation catalyst or a mixture comprising two or more different catalysts that differ in at least one property, such as structure, form, platinum group metal, complexing ligand, and thermoplastic resin.

The concentration of component (C) is sufficient to catalyze the addition reaction of component (A) with component (B). Typically, the concentration of component (C) is sufficient to provide from 0.1 to 1000 ppm of a platinum group metal, preferably from 1 to 500 ppm of a platinum group metal, and more preferably from 5 to 150 ppm of a platinum group metal, based on the combined weight of components (A) and (B). The rate of cure is very slow below 0.1 ppm of platinum group metal. The use of more than 1000 ppm of platinum group metal results in no appreciable increase in cure rate, and is therefore uneconomical.

According to another embodiment, the hydrosilylation-curable silicone composition comprises (A′) a silicone resin having the formula (R¹R⁴₂SiO_{1/2})_{w}(R⁴₂SiO_{2/2})ₓ (R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is R¹ or —H, w is from 0 to 0.8, x is from 0 to 0.6, y is from 0 to 0.99, z is from 0 to 0.35, w+x+y+z=1, y+z is from 0.2 to 0.99, and w+x is from 0.01 to 0.8, provided the silicone resin has an average of at least two silicon-bonded hydrogen atoms per molecule; (B′) an organosilicon compound having an average of at least two silicon-bonded alkenyl groups per molecule in an amount sufficient to cure the silicone resin; and (C) a catalytic amount of a hydrosilylation catalyst.

Component (A′) is at least one silicone resin having the formula (R¹R⁴₂SiO_{1/2})_{w}(R⁴₂SiO_{2/2})ₓ(R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is R¹ or —H, w is from 0 to 0.8, x is from 0 to 0.6, y is from 0 to 0.99, z is from 0 to 0.35, v+x+y+z=1, y+z is from 0.2 to 0.99, and w+x is from 0.01 to 0.8, provided the silicone resin has an average of at least two silicon-bonded hydrogen atoms per molecule invention. In the formula (II) of the silicone resin, R¹, w, x, y, z, y+z, and w+x are as described and exemplified above for the silicone resin having the formula (I).

Typically at least 50 mol %, alternatively at least 65 mol %, alternatively at least 80 mol % of the groups R⁴ in the silicone resin are hydrogen.

Examples of silicone resins having the formula (II) include, but are not limited to, resins having the following formulae: (HMe₂SiO_{1/2})_{0.25}(PhSiO_{3/2})_{0.75}, (HMeSiO_{2/2})_{0.3}(PhSiO_{3/2})_{0.6}(MeSiO_{3/2})_{0.1}, and (Me₃ SiO_{1/2})_{0.1} (H₂SiO_{2/2})_{0.1}(MeSiO_{3/2})_{0.4}(PhSiO_{3/2})_{0.4}, where Me is methyl, Ph is phenyl, and the numerical subscripts outside the parenthesis denote mole fractions. Also, in the preceding formulae, the sequence of units is unspecified.

Component (A′) can be a single silicone resin or a mixture comprising two or more different silicone resins, each as described above.

Methods of preparing silicone resins containing silicon-bonded hydrogen atoms are well known in the art; many of these resins are commercially available. Silicone resins are typically prepared by cohydrolyzing the appropriate mixture of chlorosilane precursors in an organic solvent, such as toluene. For example, a silicone resin consisting essentially of R¹R⁴₂SiO_{1/2} units and R⁴SiO_{3/2} units can be prepared by cohydrolyzing a compound having the formula R¹R⁴₂SiCl and a compound having the formula R⁴SiCl₃ in toluene, where R¹ and R⁴ are as described and exemplified above. The aqueous hydrochloric acid and silicone hydrolyzate are separated and the hydrolyzate is washed with water to remove residual acid and heated in the presence of a mild non-basic condensation catalyst to “body” the resin to the requisite viscosity. If desired, the resin can be further treated with a non-basic condensation catalyst in an organic solvent to reduce the content of silicon-bonded hydroxy groups. Alternatively, silanes containing hydrolysable groups other than chloro, such —Br, —I, —OCH₃, —OC(O)CH₃, —N(CH₃)₂, NHCOCH₃, and —SCH₃, can be utilized as starting materials in the cohydrolysis reaction. The properties of the resin products depend on the types of silanes, the mole ratio of silanes, the degree of condensation, and the processing conditions.

Component (B′) is at least one organosilicon compound having an average of at least two silicon-bonded alkenyl groups per molecule in an amount sufficient to cure the silicone resin of component (A′).

The organosilicon compound contains an average of at least two silicon-bonded alkenyl groups per molecule, alternatively at least three silicon-bonded alkenyl groups per molecule. It is generally understood that cross-linking occurs when the sum of the average number of silicon-bonded hydrogen atoms per molecule in component (A′) and the average number of silicon-bonded alkenyl groups per molecule in component (B′) is greater than four.

The organosilicon compound can be an organosilane or an organosiloxane. The organosilane can be a monosilane, disilane, trisilane, or polysilane. Similarly, the organosiloxane can be a disiloxane, trisiloxane, or polysiloxane. The structure of the organosilicon compound can be linear, branched, cyclic, or resinous. Cyclosilanes and cyclosiloxanes typically have from 3 to 12 silicon atoms, alternatively from 3 to 10 silicon atoms, alternatively from 3 to 4 silicon atoms. In acyclic polysilanes and polysiloxanes, the silicon-bonded alkenyl groups can be located at terminal, pendant, or at both terminal and pendant positions.

Examples of organosilanes suitable for use as component (B′) include, but are not limited to, silanes having the following formulae:

Vi₄Si, PhSiVi₃, MeSiVi₃, PhMeSiVi₂, Ph₂SiVi₂, and PhSi(CH₂CH═CH₂)₃, where Me is methyl, Ph is phenyl, and Vi is vinyl.

Examples of organosiloxanes suitable for use as component (B′) include, but are not limited to, siloxanes having the following formulae:

PhSi(OSiMe₂Vi)₃, Si(OSiMe₂Vi)₄, MeSi(OSiMe₂Vi)₃, and Ph₂Si(OSiMe₂Vi)₂, where Me is methyl, Ph is phenyl, and Vi is vinyl.

Component (B′) can be a single organosilicon compound or a mixture comprising two or more different organosilicon compounds, each as described above. For example component (B′) can be a single organosilane, a mixture of two different organosilanes, a single organosiloxane, a mixture of two different organosiloxanes, or a mixture of an organosilane and an organosiloxane.

The concentration of component (B′) is sufficient to cure (cross-link) the silicone resin of component (A′). The exact amount of component (B′) depends on the desired extent of cure, which generally increases as the ratio of the number of moles of silicon-bonded alkenyl groups in component (B′) to the number of moles of silicon-bonded hydrogen atoms in component (A′) increases. The concentration of component (B′) is typically sufficient to provide from 0.4 to 2 moles of silicon-bonded alkenyl groups, alternatively from 0.8 to 1.5 moles of silicon-bonded alkenyl groups, alternatively from 0.9 to 1.1 moles of silicon-bonded alkenyl groups, per mole of silicon-bonded hydrogen atoms in component (A′).

Methods of preparing organosilanes and organosiloxanes containing silicon-bonded alkenyl groups are well known in the art; many of these compounds are commercially available.

Component (C) of the second embodiment of the hydrosilylation-curable silicone composition is as described and exemplified above for component (C) of the first embodiment.

The flame retardant filler of the filled silicone composition can be any inorganic filler that imparts flame resistance (i.e., inhibits the initiation and/or spread of flame) to the silicone resin film of the present invention, as evidenced by lower heat release rate values for the silicone resin film comprising the flame retardant compared with an otherwise identical, but unfilled silicone resin film. Heat release rates can be determined as described in the Examples section below.

The flame retardant filler typically has a specific surface area of from 0.1 to 300 m²/g and preferably has a surface area of from 0.1 to 50 m²/g, as determined using the Brunauer-Ernmett-Teller (B.E.T.) method.

The flame retardant filler typically has a median particle size (based on mass) of from 0.1 to 500 μm, alternatively from 0.1 to 100 μm.

Although the shape of the flame retardant filler particles is not critical, particles having a spherical shape are preferred because they generally impart a smaller increase in viscosity to the silicone composition than particles having other shapes.

Examples of inorganic fillers include, but are not limited to, natural silicas such as crystalline silica, ground crystalline silica, and diatomaceous silica; synthetic silicas such as fused silica, silica gel, pyrogenic silica, and precipitated silica; silicates such as mica, wollastonite (calcium metasilicate), feldspar, and nepheline syenite; metal oxides such as aluminum oxide (alumina), titanium dioxide, magnesium oxide, ferric oxide, beryllium oxide, chromium oxide, titanium oxide, and zinc oxide; metal nitrides such as boron nitride, silicon nitride, and aluminum nitride, metal carbides such as boron carbide, titanium carbide, and silicon carbide; carbon black; alkaline earth metal carbonates such as calcium carbonate; alkaline earth metal sulfates such as calcium sulfate, magnesium sulfate, and barium sulfate; molybdenum disulfate; zinc sulfate; kaolin; talc; glass fiber; glass beads such as hollow glass microspheres and solid glass microspheres; metal hydroxides such as magnesium hydroxide and hydrated alumina (aluminum trihydroxide); and asbestos.

The flame retardant filer can also be a treated flame retardant filler prepared by treating the surfaces of the aforementioned inorganic fillers with an organosilicon compound. The organosilicon compound can be any of the organosilicon compounds typically used to treat silica fillers. Examples of organosilicon compounds include, but are not limited to, organochlorosilanes such as methyltrichlorosilane, dimethyldichlorosilane, and trimethyl monochlorosilane; organosiloxanes such as hydroxy-endblocked dimethylsiloxane oligomer, hexamethyldisiloxane, and tetramethyldivinyldisiloxane; organosilazanes such as hexamethyldisilazane, hexamethylcyclotrisilazane; and organoalkoxysilanes such as methyltrimethoxysilane, vinyltrimethoxysilane, vinyltriethoxysilane, 3-glycidoxypropyltrimethoxysilane, and 3-methacryloxypropyltrimethoxysilane.

The flame retardant filler can be a single flame retardant filler or a mixture comprising two or more different flame retardant fillers, each as described above.

The concentration of the flame retardant filler in the filled silicone composition is typically from 2 to 95% (w/v), alternatively from 20 to 60% (w/w), alternatively from 20 to 40% (w/w), alternatively from 25 to 40% (w/w), based on the total weight of the filled silicone composition.

The filled silicone composition of the present method can comprise additional ingredients, provided the ingredient does not prevent the silicone composition from curing to form a cured silicone resin having low flammability, as evidenced by a low heat release. Examples of additional ingredients include, but are not limited to, hydrosilylation catalyst inhibitors, such as 3-methyl-3-penten-1-yne, 3,5-dimethyl-3-hexen-1-yne, 3,5-dimethyl-1-hexyn-3-ol, 1-ethynyl-1-cyclohexanol, 2-phenyl-3-butyn-2-ol, vinylcyclosiloxanes, and triphenylphosphine; adhesion promoters, such as the adhesion promoters taught in U.S. Pat. Nos. 4,087,585 and 5,194,649; dyes; pigments; anti-oxidants; heat stabilizers; UV stabilizers; flame retardants; flow control additives; and diluents, such as organic solvents and reactive diluents.

The filled silicone composition can be a one-part composition containing the silicone resin, organosilicon compound, hydrosilylation catalyst, and flame retardant filler in a single part or, alternatively, a multi-part composition comprising these components in two or more parts.

The one-part filled silicone composition is typically prepared by combining the components of the hydrosilylation-curable silicone composition, the flame retardant filler, and any optional ingredients in the stated proportions at ambient temperature, with or without the aid of an organic solvent. Although the order of addition of the various components is not critical if the silicone composition is to be used immediately, the hydrosilylation catalyst is preferably added last at a temperature below about 30° C. to prevent premature curing of the composition. Also, the multi-part filled silicone composition can be prepared by combining the components in each part.

Mixing can be accomplished by any of the techniques known in the art such as milling, blending, and stirring, either in a batch or continuous process. The particular device is determined by the viscosity of the components and the viscosity of the final silicone composition.

The first release liner can be coated with the filled silicone composition using conventional coating techniques, such as dipping, spraying, brushing, or screen-printing. The amount of silicone composition is sufficient to form a cured silicone resin film having a thickness of from 1 to 500 μm in step (iv) of the method, described below.

In step (ii) of the method of preparing a silicone resin film, a second release liner is applied to the coated first release liner to form an assembly.

The second release liner is as described and exemplified above for the first release liner of the present method. The second release liner can be the same as the first release liner or different.

The second release liner can be applied to the coated first release liner either manually or by using commercial coating equipment.

In step (iii) of the present method, the assembly is compressed. The assembly is typically compressed to remove excess silicone composition and/or entrapped air, to reduce the thickness of the coating, and to achieve a coating of uniform thickness. The assembly can be compressed using conventional equipment such as a stainless steel roller, hydraulic press, rubber roller, nip roller, roll mill, or laminating roll set. The assembly is typically compressed at a pressure of from 1,000 Pa to 10 MPa and at a temperature of from room temperature (˜23±2° C.) to 50° C.

In step (iv) of the method of preparing a silicone resin film, the silicone resin of the compressed assembly is cured. The silicone resin of the compressed assembly can be cured by exposing the film to ambient temperature or elevated temperature. The coated release liner is typically exposed to a temperature of from room temperature (˜23±2° C.) to 250° C., alternatively from room temperature to 200° C., alternatively from room temperature to 150° C., at atmospheric pressure. The coated release liner is exposed to a particular temperature for a length of time sufficient to cure (cross-link) the silicone resin. For example, the coated release liner is typically exposed to a temperature of from 140 to 200° C. for a time of from 0.1 to 3 h.

The method can further comprise the step of separating the cured silicone resin from the release liners. The cured silicone resin can be separated from the release liners by mechanically peeling the film away from the release liners.

A silicone resin film according to the present invention comprises:

a cured product of at least one silicone resin having an average of at least two silicon-bonded alkenyl groups or silicon-bonded hydrogen atoms per molecule; and

a flame retardant filler; wherein the silicone resin film has a thickness of from 1 to 500 μm.

The silicone resin film comprises a cured product of at least one silicone resin having an average of at least two silicon-bonded alkenyl groups or silicon-bonded hydrogen atoms per molecule, where the silicone resin is as described and exemplified above for the method of the present invention. As used herein, the term “cured product of a silicone resin” refers to a cross-linked silicone resin having a three-dimensional network structure.

The silicone resin film also comprises at least one flame retardant filler, where the filler is as described and exemplified above for the method of the present invention.

The silicone resin film typically comprises from 2 to 95% (w/w), alternatively from 20 to 60% (w/w), alternatively from 20 to 40% (w/w), alternatively from 25 to 40% (w/w), of the flame retardant filler, based on the total weight of the silicone resin film.

The silicone resin film of the present invention typically has a thickness of from 1 to 500 μm, alternatively from 15 to 500 μm, alternatively from 15 to 300 μm, alternatively from 20 to 150 μm, alternatively from 30 to 125 μm.

The silicone resin film typically has a flexibility such that the film can be bent over a cylindrical steel mandrel having a diameter less than or equal to 3.2 mm without cracking, where the flexibility is determined as described in ASTM Standard D522-93a, Method B.

The silicone resin film has low coefficient of linear thermal expansion (CTE), high tensile strength, and high modulus. For example the film typically has a CTE of from 50 to 200 μm/m° C., alternatively from 50 to 150 μm/m° C., alternatively from 60 to 100 μm/m° C., at temperature of from room temperature (˜23±2° C.) to 200° C. Also, the film typically has a tensile strength at 25° C. of from 5 to 200 MPa, alternatively from 10 to 100 MPa, alternatively from 15 to 75 MPa. Further, the silicone resin film typically has a Young's modulus at 25° C. of from 0.5 to 10 GPa, alternatively from 1 to 6 GPa, alternatively from 1 to 3 GPa.

The transparency of the silicone resin film depends on a number of factors, such as the composition of the cured silicone resin, the thickness of the film, and the type and concentration of the flame retardant filler. The silicone resin film typically has a transparency (% transmittance) of at least 50%, alternatively at least 60%, alternatively at least 75%, alternatively at least 85%, in the visible region of the electromagnetic spectrum.

The silicone resin film of the present invention has low flammability, as evidenced by a low heat release rate, compared with a similar silicone resin film lacking only the flame retardant filler. For example, the silicone resin film typically has a peak heat release rate less than 60 kW/m², alternatively less than 50 kW/m², alternatively less than 40 kW/m².

The silicone resin film of the present invention has low coefficient of thermal expansion, high tensile strength, high modulus, and low flammability compared to a silicone resin film prepared from the same silicone composition absent the flame retardant filler.

The silicone resin film of the present invention is useful in applications requiring films having low flammability, and high thermal stability, flexibility, mechanical strength, and transparency. For example, the silicone resin film can be used as an integral component of flexible displays, solar cells, flexible electronic boards, side interior panels and ceiling panels for aircraft, touch screens, fire-resistant wallpaper, and impact-resistant windows. The film is also a suitable substrate for transparent or nontransparent electrodes.

### EXAMPLES

The following examples are presented to better illustrate the silicone resin film and method of the present invention, but are not to be considered as limiting the invention, which is delineated in the appended claims. Unless otherwise noted, all parts and percentages reported in the examples are by weight. The following methods and materials were employed in the examples:

### Measurement of Mechanical Properties

Young's modulus, tensile strength, and tensile strain at break were measured using an MTS Alliance RT/5 testing frame, equipped with a 100-N load cell. Young's modulus, tensile strength, and tensile strain were determined at room temperature (˜23±2° C.) for the test specimens of Example 4, Example 5, and Comparative Example 2.

The test specimen was loaded into two pneumatic grips spaced apart 25 mm and pulled at a crosshead speed of 1 mm/min. Load and displacement data were continuously collected. The steepest slope in the initial section of the load-displacement curve was taken as the Young's modulus.

The highest point on the load-displacement curve was used to calculate the tensile strength according to the equation:

σ=F/(wb),

where:
σ=tensile strength, MPa,
F=highest force, N,
w=width of the test specimen, mm, and
b=thickness of the test specimen, mm.

Reported values for Young's modulus (MPa) and tensile strength (MPa) each represent the average of three measurements made on different dumbbell-shaped test specimens from the same silicone resin film.

### Measurement of Heat Release Rate

The heat release rates (2 min. and peak) of silicone resin films were determined using the Ohio State University (OSU) Rate of Heat Release Apparatus specified in FAR (Federal Aviation Regulation) Part 25.853 [a-1], which defines both the apparatus and the pass/fail criteria for aircraft interior materials, such as sidewall panels, bulkheads, and stowage bins. Test coupons were prepared by bonding the silicone resin film to a sidewall fiberglass panel used as a decorative laminate for aircraft, having a thickness of 0.125 in. Reported values for heat release rate each represent the average of 3-4 measurements made on different test specimens containing the same silicone resin film.

Hydral® 710, which is sold by Almatis, Inc. (Bauxite, Ariz.), is a finely divided high purity (99.5%) aluminum trihydroxide powder having a median particle size of about 1.0 μm, a density of 2.42 g/cm³, and an average surface area of 4.0 m²/g (B.E.T. method).

SpectrAl™ 51, which is sold by Cabot Corporation (Billerica, Mass.), is a high purity fumed alumina (>99.8% Al₂O₃) having a surface area of 55 m²/g (B.E.T. method) and a specific gravity of 3.6.

Nyad® 1250, which is sold by Nyco Minerals, Inc. (Willsboro, N.Y.), is a Wollastonite (calcium metasilicate) filler having a median particle size (granulometer) of 3.5 μm, a surface area of 2.6 m²/g, and an aspect ratio (L:D) of 3:1.

PET Film is a polyethyleneterephthalate (PET) film having a thickness of either 0.075 mm or 0.1 mm.

Teflon® Sheet, obtained from McMaster-Carr (Atlanta, Ga.), is a Virgin Electrical Grade Teflon® sheet having a thickness of 0.005 in.

Platinum Catalyst is a hydrosilylation catalyst containing 1000 ppm of platinum in toluene. The catalyst was prepared by treating a platinum(0) complex of 1,1,3,3-tetramethyldisiloxane in the presence of a large molar excess of 1,1,3,3-tetramethyldisiloxane, with triphenylphosphine to achieve a mole ratio of triphenylphosphine to platinum of about 4:1.

Silicone Resin A: a silicone resin having the formula (PhSiO_{3/2})_{0.75}(ViMe₂SiO_{1/2})_{0.25}, where the resin has a weight-average molecular weight of about 1700, a number-average molecular weight of about 1440, and contains about 1 mol % of silicon-bonded hydroxy groups.

Silicone Resin B: a silicone resin having the formula (SiO_{4/2})_{0.10}(PhSiO_{3/2})_{0.75} (ViMe₂SiO)_{0.15}, where the resin has a weight-average molecular weight of about 2420, a number-average molecular weight of about 1760, and contains about 1.5 mol % of silicon-bonded hydroxy groups.

### Example 1

Silicone Resin A (274 g), 502 g of Silicone Resin B, and 156 g of toluene were mixed thoroughly. The mixture was heated at 90-100° C. under reduced pressure to remove most of the toluene. The vacuum was discontinued and 127 g of 1,4-Bis(dimethylsilyl)-benzene was added to the mixture. The pressure was reduced to 2 kPa and the temperature was maintained at 90° C. for 30 min. The vacuum was again discontinued and 1,4-bis(dimethylsilyl)benzene was added in an amount sufficient to restore the mole ratio SiH/Vi to 1:1.

The preceding silicone mixture (80 g), 20 g of Hydral® 710, and 0.08 g of triphenylphosphine were mixed manually using a spatula. The components were further mixed for ten consecutive 30-second cycles using a Mikrona dental mixer. The resulting mixture was treated with Platinum Catalyst in an amount sufficient to achieve a concentration of 2 ppm of platinum. The components were then mixed for two consecutive 30-second cycles using the dental mixer. The silicone composition was placed between two PET Films (40.6 cm×40.6 cm×75 μm) using a spatula. An identical PET Film was applied to the coated PET Film and the assembly was fed through a nip roller having a gap of 0.0090 in. The assembly was heated at 130° C. for 8 min. and then at 145° C. for 30 min. The laminate was allowed to cool to room temperature. The upper PET Film was separated (peeled away) from the silicone resin film, and the silicone resin film was then separated from the lower PET Film. The heat release properties of the silicone resin film are shown in Table. 1.

### Example 2

Silicone Resin A (57.9 g), 12.1 g of 1,4-bis(dimethylsilyl)benzene, 0.07 g of triphenylphosphine, and 30 g of Hydral® 710 were mixed manually using a spatula. The components were further mixed for ten consecutive 30-second cycles using a Mikrona dental mixer. The resulting mixture was treated with Platinum Catalyst in an amount sufficient to achieve a concentration of 2 ppm of platinum. The components were then mixed for two consecutive 30-second cycles using the dental mixer. A silicone resin film was prepared using this silicone composition and the method of Example 1. The heat release properties of the silicone resin film are shown in Table. 1.

### Example 3

Silicone Resin A (49.6 g), 10.4 g of 1,4-bis(dimethylsilyl)benzene, 0.06 g of triphenylphosphine, and 40 g of Hydral® 710 were mixed manually using a spatula. The components were further mixed for ten consecutive 30-second cycles using a Mikrona dental mixer. The resulting mixture was treated with Platinum Catalyst in an amount sufficient to achieve a concentration of 2 ppm of platinum. The components were then mixed for two consecutive 30-second cycles using the dental mixer. A silicone resin film was prepared using this silicone composition and the method of Example 1. The heat release properties of the silicone resin film are shown in Table. 1.

### Comparative Example 1

Silicone Resin B (20.0 g), 17.1 g of toluene and 2.7 g of 1,4-Bis(dimethylsilyl)-benzene were mixed manually using a spatula. The resulting mixture was treated with Platinum Catalyst in an amount sufficient to achieve a concentration of 2 ppm of platinum. The components were then mixed for two consecutive 30-second cycles using a Mikrona dental mixer. The silicone composition was coated on a PET Film using an applicator. The solvent was allowed to evaporate and the coated film was heated at 100° C. for 1 h and then at 150° C. for 2 h. The silicone resin film was then separated from the PET Film. The heat release properties of the silicone resin film are shown in Table 1.

### Example 4

Nyad® 1250 (20.0 g), was added in two equal portions to 30.0 g of a mixture of 24.54 g of Silicone Resin A and 5.46 g of 1,4-bis(dimethylsilyl)benzene. The mixture was blended by hand using a spatula, and then mixed for 14 seconds using a Hauschild dental mixer. Platinum Catalyst (0.5%, based on the weight of the blend) was added to the mixture and the components were mixed by hand using a spatula and then mixed for 14 seconds using a Hauschild mixer. The addition of catalyst and mixing procedure were repeated three times. The silicone composition was placed between two PET Films (40.1 cm×22.9 cm) using a pipette. The assembly was then fed through an adjustable two roll mill having a roll gap of 0.0100-0.0150 in. and a roll speed of 5 rpm. The laminate was heated in a forced air oven from room temperature to 120° C. at 5° C./min. and then held at 120° C. 1 h. The laminate was allowed to cool to room temperature and the silicone resin film was separated from the PET sheets. The silicone resin film was placed between two Teflon Sheets and heated at 140° C. for 2 h. The heat release properties of the silicone resin film are shown in Table. 1.

### Example 5

Phenyltrimethoxysilane (1.66 g) was added to 159.59 g of a mixture containing 93-94% of Silicone Resin A and 6-7% of toluene in a Baker Perkins mixer. Then 81.74 g of SpectrAl™ 51 fumed alumina was added to the mixture in portions of 5 to 10 g. After the addition of about one-half of the filler, 1.25 g of vinyltrimethoxysilane (filler treating agent) was added to the blend. After completion of the addition of the fumed alumina, the blend was mixed at room temperature for 15 min.

The blend was heated in the mixer to 100° C. during a period of 20 min. Once the sample reached 100° C., a vacuum was applied to the system to remove any residual toluene and/or treating agent. The sample was mixed under vacuum (˜25 in. Hg) and elevated temperatures at a temperature of from 100-129° C. for 40 min. The pressure was returned to atmospheric level and the sample was allowed to cool to ˜100° C. Once the sample reached ˜100° C., Silicone Resin A and 1,4-bis(dimethylsilyl)benzene were slowly added to the blend to achieve a 1:1 Si—H/Vi ratio. This process took about 1 hour to complete. After the addition was complete, the blend was mixed for an additional 1 h, 10 min. The final concentration of fumed alumina in the blend was 20.3%.

Platinum Catalyst (0.5%, based on the weight of the blend) was added to the preceding mixture and the components were mixed by hand using a spatula and then mixed for 14 seconds using a Hauschild mixer. The addition of catalyst and mixing procedure were repeated three times. The composition was placed between two PET Films (40.1 cm×22.9 cm) using a pipette. The assembly was then fed through an adjustable two roll mill having a roll gap of 0.0100-0.0150 in. and a roll speed of 5 rpm. The laminate was heated in a forced air oven from room temperature to 120° C. at 5° C./min. and then held at 120° C. 1 h. The laminate was allowed to cool to room temperature and the silicone resin film was separated from the PET sheets. The silicone resin film was disposed between two Teflon Sheets and heated at 140° C. for 2 h. The heat release properties of the silicone resin film are shown in Table. 1.

### Comparative Example 2

A silicone resin film was prepared according to the method of Example 4, except Nyad® 1250 was omitted in the preparation of the silicone composition.

TABLE 1

| | Thickness | Test | Total HRR at 2 min. | Peak HRR |
|---|---|---|---|---|
| Example | (μm) | Surface | (kW-min/m²) | (kW/m²) |
| 1 | 50 | 1 | 38.57 ± 2.68 | 40.32 ± 1.00 |
| | | 2 | 38.15 ± 2.59 | 31.56 ± 2.37 |
| 2 | 25 | 1 | 37.04 ± 2.13 | 40.19 ± 1.76 |
| | | 2 | 39.82 ± 1.30 | 39.97 ± 1.78 |
| 3 | 50 | 1 | 37.77 ± 2.92 | 39.76 ± 1.86 |
| | | 2 | 40.92 ± 3.71 | 34.26 ± 2.71 |
| 4 | 84 | 2 | 43.74 ± 3.35 | 33.62 ± 0.04 |
| 5 | 76 | 2 | 53.06 ± 3.27 | 39.86 ± 1.94 |
| Comp. Ex. 1 | 65 | 1 | 48.98 ± 1.52 | 41.34 ± 1.21 |
| | | 2 | 39.60 ± 5.95 | 34.29 ± 4.02 |
| | Sidewall | 1 | 44.03 ± 1.84) | 45.24 ± 1.10 |
| | panel | | | |

Thickness refers to thickness of the silicone resin film, and HRR denotes Heat Release Rate, and Test Surface refers to the exposed side of the silicone resin film (side 1: top; side 2: bottom) in Examples 1-5, or the exposed side of the sidewall panel (side 1: honeycomb side) in Comparative Example 1.

TABLE 2

| | Thickness | Tensile Strength | Young's Modulus |
|---|---|---|---|
| Example | (μm) | (MPa) | (MPa) |
| 4 | 80 | 23.4 ± 5.1 | 1985 ± 270 |
| 5 | 90 | 23.1 ± 1.6 | 1142 ± 73 |
| Comp. Ex. 2 | 90 | 21.8 ± 0.9 | 927 ± 53 |

That which is claimed is:

1. A method of preparing a silicone resin film, the method comprising:
(i) coating a first release liner with a filled silicone composition, wherein the filled silicone composition comprises:
a hydrosilylation-curable silicone composition comprising a silicone resin having an average of at least two silicon-bonded alkenyl groups or silicon-bonded hydrogen atoms per molecule, and
a flame retardant filler;
(ii) applying a second release liner to the coated first release liner to form an assembly;
(iii) compressing the assembly; and
(iv) curing the silicone resin of the compressed assembly; wherein the silicone resin film has a thickness of from 1 to 500 μm.

2. The method according to claim 1, wherein the hydrosilylation-curable silicone composition comprises (A) a silicone resin having the formula (R¹R²₂SiO_{1/2})_{w}(R²₂SiO_{2/2})ₓ (R¹SiO_{3/2})_{y}(SiO_{4/2})_{z} (1), wherein R¹ is C₁ to C₁₀ hydrocarbyl or C₁ to C₁₀ halogen-substituted hydrocarbyl, both free of aliphatic unsaturation, R² is R¹ or alkenyl, w is from 0 to 0.8, x is from 0 to 0.6, y is from 0 to 0.99, z is from 0 to 0.35, w+x+y+z=1, y+z is from 0.2 to 0.99, and w+x is from 0.01 to 0.8, provided the silicone resin has an average of at least two silicon-bonded alkenyl groups per molecule; (B) an organosilicon compound having an average of at least two silicon-bonded hydrogen atoms per molecule in an amount sufficient to cure the silicone resin; and (C) a catalytic amount of a hydrosilylation catalyst.

3. The method according to claim 2, wherein the organosilicon compound has the formula HR¹₂Si—R³—SiR¹₂H, wherein R¹ is C₁ to C₁₀ hydrocarbyl or C₁ to C₁₀ halogen-substituted hydrocarbyl, both free of aliphatic unsaturation, and R³ is a hydrocarbylene group free of aliphatic unsaturation having a formula selected from: 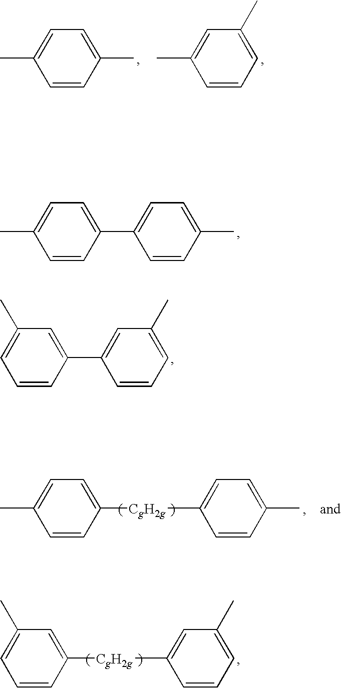
wherein g is from 1 to 6.

4. The method according to claim 1, wherein the hydrosilylation-curable silicone composition comprises (A′) a silicone resin having the formula (R¹R⁴₂SiO_{1/2})_{w}(R⁴₂SiO_{2/2})ₓ (R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is R¹ or —H, w is from 0 to 0.8, x is from 0 to 0.6, y is from 0 to 0.99, z is from 0 to 0.35, w+x+y+z=1, y+z is from 0.2 to 0.99, and w+x is from 0.01 to 0.8, provided the silicone resin has an average of at least two silicon-bonded hydrogen atoms per molecule; (B′) an organosilicon compound having an average of at least two silicon-bonded alkenyl groups per molecule in an amount sufficient to cure the silicone resin; and (C) a catalytic amount of a hydrosilylation catalyst.

5. The method according to claim 1, wherein the silicone resin film has a thickness of from 15 to 300 μm.

6. The method according to claim 1, wherein the flame retardant filler is selected from aluminum trihydroxide and fumed alumina.

7. A silicone resin film prepared according to the method of claim 1.

8. A silicone resin film comprising:
a cured product of at least one silicone resin having an average of at least two silicon-bonded alkenyl groups or silicon-bonded hydrogen atoms per molecule; and
a flame retardant filler; wherein the silicone resin film has a thickness of from 1 to 500 μm.

9. The silicone resin film according to claim 8, wherein the silicone resin has the formula (R¹R²₂SiO_{1/2})_{w}(R²₂SiO_{2/2})ₓ (R¹SiO_{3/2})_{y}(SiO_{4/2})_{z} (I), wherein R¹ is C₁ to C₁₀ hydrocarbyl or C₁ to C₁₀ halogen-substituted hydrocarbyl, both free of aliphatic unsaturation, R² is R¹ or alkenyl, w is from 0 to 0.8, x is from 0 to 0.6, y is from 0 to 0.99, z is from 0 to 0.35, w+x+y+z=1, y+z is from 0.2 to 0.99, and w+x is from 0.01 to 0.8, provided the silicone resin has an average of at least two silicon-bonded alkenyl groups per molecule.

10. The silicone resin film according to claim 8, wherein the silicone resin had the formula (R¹R⁴₂SiO_{1/2})_{w}(R⁴₂SiO_{2/2})ₓ (R⁴SiO_{3/2})_{y}(SiO_{4/2})_{z} (II), wherein R¹ is C₁ to C₁₀ hydrocarbyl or C₁ to C₁₀ halogen-substituted hydrocarbyl, both free of aliphatic unsaturation, R⁴ is R¹ or —H, w is from 0 to 0.8, x is from 0 to 0.6, y is from 0 to 0.99, z is from 0 to 0.35, w+x+y+z=1, y+z is from 0.2 to 0.99, and w+x is from 0.01 to 0.8, provided the silicone resin has an average of at least two silicon-bonded hydrogen atoms per molecule.

11. The silicone resin film according to claim 8, wherein the silicone resin film has a thickness of from 15 to 300 μm.

12. The silicone resin film according to claim 8, wherein the flame retardant filler is selected from aluminum trihydroxide and fumed alumina.
